(19) United States
(12) Patent Application Publication
(10) Pub. No.: US 2017/0220295 A1
(43) Pub. Date: Aug. 3, 2017

(54) TECHNOLOGIES FOR REDUCING DUPLICATION OF STORED DATA

(71) Applicant: Intel Corporation, Santa Clara, CA (US)

(72) Inventors: Jawad B. Khan, Cornelius, OR (US); Sanjeev N. Trika, Portland, OR (US); Vinodh Gopal, Westborough, MA (US); Mahesh S. Maddury, Santa Clara, CA (US); Omid J. Azizi, Redwood City, CA (US)

(21) Appl. No.: 15/013,183

(22) Filed: Feb. 2, 2016

(51) Int. Cl. G06F 3/06

(52) U.S. Cl. CPC G06F 3/0652; G06F 3/0608; G06F 3/0688; G06F 3/067

(57) ABSTRACT

Technologies for reducing duplication of stored data include storing, by a controller of an apparatus, a first data sub-block of a plurality of data sub-blocks of a data block in a memory at a first physical address. The technologies additionally include storing, by the controller, a pointer in a pointer table. The pointer points to the first physical address. The technologies also include determining, by the controller, whether a second data sub-block of the plurality of data sub-blocks is a duplicate of the first data sub-block, and storing, by the controller in response to a determination that the second data sub-block is a duplicate of the first data sub-block, a second pointer in the pointer table. The second pointer points to the first physical address.

### BACKGROUND

Data storage operations on storage devices, such as solid state drives, hard disk drives, and memory devices generally include receiving an instruction to store a block of data and storing the data in a corresponding location on the storage device. In some cases, the data block to be stored may include one or more sub-blocks of data that are duplicative of other sub-blocks being stored. For example, one sub-block and another sub-block may contain identical data. In conventional storage devices, valuable storage space may be consumed unnecessarily when the storage device stores an entire data block including duplicative data therein.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a data storage device for performing a data deduplication operation;

FIG. 2 is a simplified block diagram of at least one embodiment of an environment that may be established by the data storage device of FIG. 1;

FIGS. 3 and 4 are a simplified flow diagram of at least one embodiment of a method for performing a data deduplication operation that may be executed by the data storage device of FIGS. 1 and 2;

FIG. 5 is a simplified flow diagram of at least one embodiment of a method for trimming (i.e., deleting) data that may be executed by the data storage device of FIGS. 1 and 2;

FIG. 6 is a simplified flow diagram of at least one embodiment of a method for writing data that may be executed by the data storage device of FIGS. 1 and 2;

FIG. 7 is a simplified flow diagram of at least one embodiment of a method for reading data that may be executed by the data storage device of FIGS. 1 and 2;

FIG. 8 is a simplified block diagram of various instructions that may be received by the storage device of FIGS. 1 and 2;

FIG. 9 is a simplified block diagram of the storage of data by the data storage device of FIGS. 1 and 2 in accordance with the method of FIGS. 3 and 4;

FIG. 10 is a simplified block diagram of the reconstruction of data by the data storage device of FIGS. 1 and 2 in response to a read instruction; and

FIG. 11 is a simplified block diagram of at least one embodiment of a computing device including the data storage device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

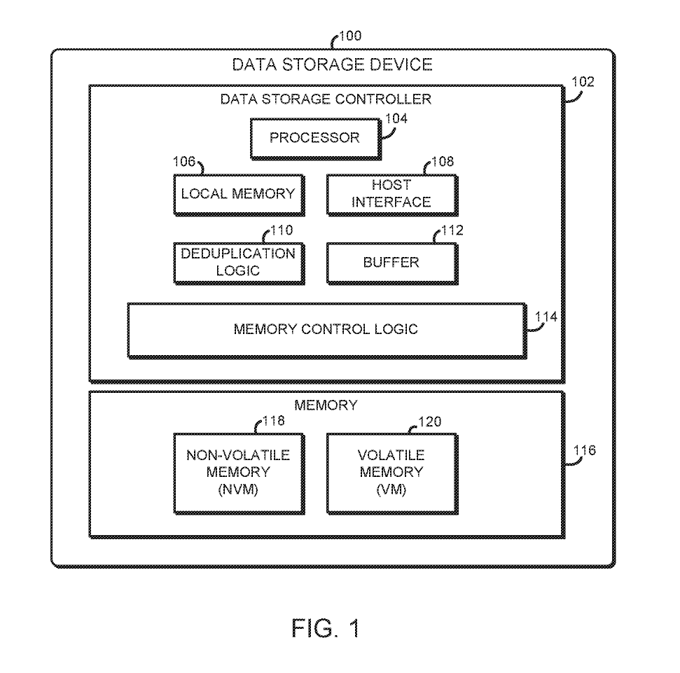

As shown in FIG. 1, an illustrative data storage device 100 for performing a data deduplication operation includes a data storage controller 102 and a memory 116, which illustratively includes non-volatile memory 118 and volatile memory 120. As discussed in more detail below, in use, the data storage controller 102 is configured to perform a data deduplication operation in response to a data storage instruction from a host. The data storage controller 102 may perform the data deduplication operation at the time at which the requested data storage is performed or some time thereafter. For example, in embodiments, the data storage device 100 may delay or defer the data deduplication process to a time after the data has been written to the memory 116 (e.g., as part of a garbage collection or defragmentation process).

The data storage controller 102 is configured to perform the deduplication operation in response to a data storage instruction by comparing each sub-block of a data block to be stored to previously stored sub-blocks. To do so, as discussed in detail below, the data storage device 100 stores an initial sub-block of the data block in a data table, which may be embodied as a data table associated with the data block to be stored or as a global data table. Additionally, a pointer to the physical address of the location in the data block at which the sub-block is stored is added to a data pointer table associated with the data block to be stored. As subsequent sub-blocks of the data block are to be written to the data table, the data storage device 100 compares each subsequent sub-block to the previously stored sub-blocks to determine whether the particular sub-block is duplicative of an earlier stored sub-block. As discussed below, the data storage device may use one of multiple methods to determine if sub-blocks are duplicates.

If a subsequent sub-block is not a duplicate of any previously stored sub-blocks, the subsequent sub-block is stored in the data table and a new pointer is added to the data pointer table. However, if the subsequent sub-block is a duplicate of a previously stored sub-block, the data storage controller 102 does not store the subsequent sub-block in the data table, but does store a new pointer to the physical address of the duplicated, previously-stored data sub-block in the data pointer table. As discussed further below, the data storage controller 102 may also maintain a reference count of the number of pointers to each physical address of the data table (i.e., how many pointers are pointing to a particular data sub-block stored in the data table).

It should be appreciated that, by performing the described deduplication operation, the data storage device 100 conserves capacity of the memory 116, which can be used to store additional data. In some embodiments, the data storage controller 102 may be configured to optionally or responsively perform the deduplication operation during the write of new data. For example, the storage instruction may include an indicator specifying that the deduplication operation is not to be performed on a particular data block (e.g., indicating that the data block is “critical”). In response, the data storage controller 102 may independently store each sub-block of the data block in the corresponding data table, regardless of any duplication of those sub-blocks.

The data storage device 100 may be embodied as any type of device capable of storing data and performing the functions described herein. In the illustrative embodiment, the data storage device 100 is embodied as a solid state drive; however, in other embodiments, the data storage device 100 may embodied as other storage devices such as a hard disk drive, a memory module device, a cache memory device, and/or other data storage device.

The data storage controller 102 of the data storage device 100 may be embodied as any type of control device, circuitry, or collection of hardware devices capable of performing a data deduplication process on the non-volatile memory 118. In the illustrative embodiment, the data storage controller 102 includes a processor or processing circuitry 104, local memory 106, a host interface 108, deduplication logic 110, a buffer 112, and memory control logic 114. Of course, the data storage controller 102 may include additional devices, circuits, and/or components commonly found in a drive controller of a solid state drive in other embodiments.

The processor 104 may be embodied as any type of processor capable of performing the functions described herein. For example, the processor 104 may be embodied as a single or multi-core processor(s), digital signal processor, Field Programmable Gate Arrays (FPGA), microcontroller, or other processor or processing/controlling circuit. Similarly, the local memory 106 may be embodied as any type of volatile and/or non-volatile memory or data storage capable of performing the functions described herein. In the illustrative embodiment, the local memory 106 stores firmware and/or other instructions executable by the processor 104 to perform the described functions of the data storage controller 102. In some embodiments, the processor 104 and the local memory 106 may form a portion of a System-on-a-Chip (SoC) and be incorporated, along with other components of the data storage controller 102, onto a single integrated circuit chip.

The host interface 108 may also be embodied as any type of hardware processor, processing circuitry, input/output circuitry, and/or collection of components capable of facilitating communication of the data storage device 100 with a host device or service (e.g., a host application). That is, the host interface 108 embodies or establishes an interface for accessing data stored on the data storage device 100 (e.g., stored in the memory 116). To do so, the host interface 108 may be configured to utilize any suitable communication protocol and/or technology to facilitate communications with the data storage device 100 depending on the type of data storage device. For example, the host interface 108 may be configured to communicate with a host device or service using Serial Advanced Technology Attachment (SATA), Peripheral Component Interconnect express (PCIe), Serial Attached SCSI (SAS), Universal Serial Bus (USB), and/or other communication protocol and/or technology in some embodiments.

In the illustrative embodiment, the deduplication logic 110 is embodied as dedicated circuitry and/or device configured to perform at least a portion of the data deduplication operations described herein. For example, the deduplication logic 110 may be embodied as a co-processor, an application specific integrated circuit (ASIC), or other dedicated circuitry or device. In such embodiments, the data deduplication logic 110 provides a hardware accelerated implementation of the deduplication operations described herein. In other embodiments, at least a portion of the deduplication logic 110 may be embodied as firmware or other processor-executable instructions.

The buffer 112 of the data storage controller 102 is embodied as volatile memory used by data storage controller 102 to temporarily store data that is being read from or written to memory 116. The particular size of the buffer 112 may be dependent on the total storage size of the memory 116. The memory control logic 114 is illustrative embodied as hardware circuitry and/or device configured to control the read/write access to data at particular storage locations of memory 116.

The non-volatile memory 118 may be embodied as any type of data storage capable of storing data in a persistent manner (even if power is interrupted to non-volatile memory 118). For example, in the illustrative embodiment, the non-volatile memory 118 is embodied as one or more non-volatile memory devices. The non-volatile memory devices of the non-volatile memory 118 are illustratively embodied as byte-addressable, write-in-place non-volatile memory devices. However, in other embodiments, the non-volatile memory 118 may be embodied as any combination of memory devices that use chalcogenide phase change material (e.g., chalcogenide glass), three-dimensional (3D) crosspoint memory, or other types of byte-addressable, write-in-place non-volatile memory, ferroelectric random-access memory (FeTRAM), nanowire-based non-volatile memory, phase change memory (PCM), memory that incorporates memristor technology, Magnetoresistive random-access memory (MRAM) or Spin Transfer Torque (STT)-MRAM.

The volatile memory 120 may be embodied as any type of data storage capable of storing data while power is supplied to the volatile memory 120. For example, in the illustrative embodiment, the volatile memory 120 is embodied one or more volatile memory devices, and is periodically referred to hereinafter as volatile memory 120 with the understanding that the volatile memory 120 may be embodied as other types of non-persistent data storage in other embodiments. The volatile memory devices of the volatile memory 120 are illustratively embodied as dynamic random-access memory (DRAM) devices, but may be embodied as other types of volatile memory devices and/or memory technologies capable of storing data while power is supplied to volatile memory 120.

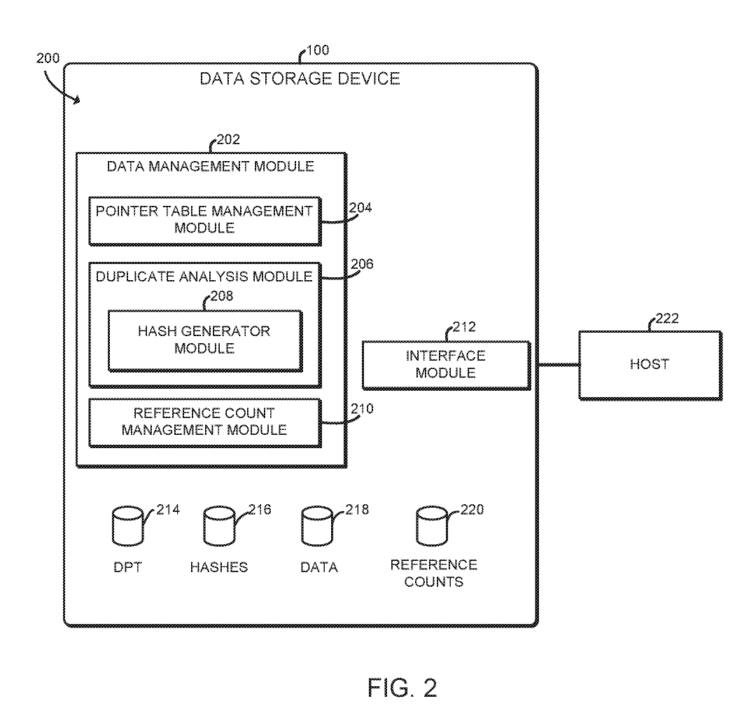

Referring now to FIG. 2, in use, the data storage device 100 may establish an environment 200. The illustrative environment 200 includes a data management module 202 and an interface module 212. The data management module 202 further includes a pointer table management module 204, a duplicate analysis module 206 that includes a hash generator module 208, and a reference count management module 210. Further, the data storage device 100 includes an interface module 212. Additionally, the data storage device 100 includes one or more data pointer tables 214, hashes 216, data 218, for example one or more data tables, and reference counts 220. Data management module 202 accesses data pointer tables 214, hashes 216, data 218, and reference counts 220 in performing the deduplication operations described herein. Each of the modules and other components of the environment 200 may be embodied as firmware, software, hardware, or a combination thereof. For example the various modules, logic, and other components of the environment 200 may form a portion of, or otherwise be established by, the data storage controller 102 or other hardware components of the data storage device 100. As such, in some embodiments, any one or more of the modules of the environment 200 may be embodied as a circuit or collection of electrical devices (e.g., a data management circuit 202, a pointer table management circuit 204, a duplicate analysis circuit 206, a hash generator circuit 208, a reference count management circuit 210, an interface circuit 212, etc.).

The data management module 202 is configured to manage the writing, reading, and trimming (i.e., deleting) of data from the memory 116 using the deduplication technologies described herein. For example, when writing data, the data management module 202 is configured to receive a data block to be stored and store data sub-blocks of the data block in a data table 218 associated with the data block (or in a global data table). To do so, the duplicate analysis module 206 analyzes each data sub-block to determine whether the present data sub-block is a duplicate (i.e., contains the same data) as a previously stored data sub-block as discussed below. Additionally, the pointer table management module 204 is configured to store pointers to physical addresses within the data table 218 at which each sub-block is stored. If the duplicate analysis module 206 determines that two or more sub-blocks contain the same data, the pointer table management module 204 stores a pointer to the physical address in the data table 218 at which the actual data is stored. Accordingly, the pointer is stored multiple times, once per sub-block. Illustratively, the pointer table management module 204 stores the pointers in a data pointer table 214 associated with the particular data block (although global data pointer table may be used in some embodiments). In some embodiments, the data pointer table 214 may be stored in the memory 116. As described in more detail herein, the data pointer table 214 is arranged such that each data sub-block in a stored data block has an associated entry (e.g., pointer) in the data pointer table 214. When the data management module 202 reads a data block, the pointer table management module 204 traverses the data pointer table 214 associated with the data block to be read to obtain the physical addresses pointed to by each sequential pointer in the data pointer table 214. The data management module 202 accesses data stored at the physical addresses in the corresponding data table 218 and reassembles the data block. The data management module 202 then passes the assembled data block to the interface module 212, for example by storing the data block at a location in the buffer 112 and transmitting the address of the location to the interface module 212.

As discussed above, the duplicate analysis module 206 analyzes whether a particular data sub-block is a duplicate (e.g., contains the same data) of a previously stored sub-block when the data block is being written to the memory 116 (and/or during a garbage collection process as discussed herein). More specifically, in at least some embodiments, the duplicate analysis module 206 is configured to analyze whether a particular sub-block is a duplicate of any previously stored sub-block, regardless of whether the previously stored sub-block is in the same data block, or in a different data block. To do so, the duplicate analysis module 206 illustratively includes a hash generator 208 configured to generate a hash 216 of each sub-block of a data block to be stored, as described in more detail below. In some embodiments, the hash generator module 208 is hardware accelerated such that at least a portion of the functions are performed by circuitry (e.g., deduplication logic 110) specifically designed to perform the functions, rather than being performed by a general purpose processor. The hash generator module 208 may be configured to generate hashes 216 that are representative of and act as signatures of the data in the corresponding sub-blocks. In some embodiments, the hash generator module 208 may be configured to generate hashes such that at least a portion of each hash 216 is usable as an index into an address space at which the sub-block is stored. In this method, referred to herein as hash based index addressing, at least a portion of the computed hash acts as an address range (i.e., a pointer) and this address range has several locations (i.e., entries) in which that data sub-block may be stored. In at least some embodiments, each stored address range (i.e., pointer) may include bits that indicate which entry in the address range contains the exact data of the stored data sub-block. If all entries become full, the last entry may point to an extra location that contains the data of the data sub-block. When determining whether a particular sub-block to be written to non-volatile memory is a duplicate of a previously-stored sub-block, the duplicate analysis module 206 may access the data sub-blocks, if any, stored in respective entries in the physical address range indicated by the hash and perform a bit-by-bit or byte-by-byte comparison of the particular sub-block to each previously-stored sub-block. In other embodiments that do not use hash based index addressing, the data storage device 100 may store pointers to each sub-block and store hashes of the sub-blocks as well. In such embodiments, the duplicate analysis module 206 may compare a hash of a new sub-block to hashes of previously-stored sub-blocks, and if there is a match, subsequently perform a bit-by-bit or byte-by-byte comparison of the two sub-blocks to determine if one is identical to (i.e., a duplicate of) the other.

The reference count management module 210 selectively sets, increases, and decreases reference counts 220 associated with the physical addresses in the data tables 218 at which corresponding data sub-blocks are stored. The reference counts 220 indicate the number of pointers that presently point to a particular physical address in a data table 218. For example, when a data sub-block is initially stored in a data table 218 and the data sub-block is not a duplicate of another data sub-block, the reference count management module 210 sets the reference count associated with the physical address in the data table 218 at which the data sub-block is stored to one, which indicates one pointer in the corresponding data pointer table 214 points to that physical address. If a later-stored sub-block is a duplicate of the earlier-stored data sub-block, the reference count management module 210 increments the reference count 220 associated with the physical address, indicating that an additional pointer in the data pointer table 214 points to the above-mentioned physical address in the data table 218. If a data sub-block is trimmed (i.e., deleted), the reference count management module 210 decrements the reference count associated with the corresponding physical address in the data table 218. A reference count of zero indicates that the corresponding physical address is unused and is available for storage of a data sub-block.

The interface module 212 is configured to handle various instructions, including but not limited to, data storage instructions, data read instructions, and data trimming instructions received from a host 222, which may be embodied as an application, service, and/or other device. In some embodiments, the interface module 212 may be configured to handle other instructions as well, including self-monitoring, analysis and reporting technology (“SMART”) instructions, and other instructions defined in the non-volatile memory express (“NVMe”) specification. To handle the various instructions, the interface module 212 is configured to identify a received instruction and any data and/or parameters associated with the instruction, and transmit those items to the data management module 202. For example, in response to a read instruction, the interface module 212 transmits the data read by the data management module 202 to the host 222. Conversely, in response to a write instruction and/or a trim instruction, the interface module 212 may transmit a result of the instruction to the host 222, for example a confirmation that the instruction was received and/or completed.

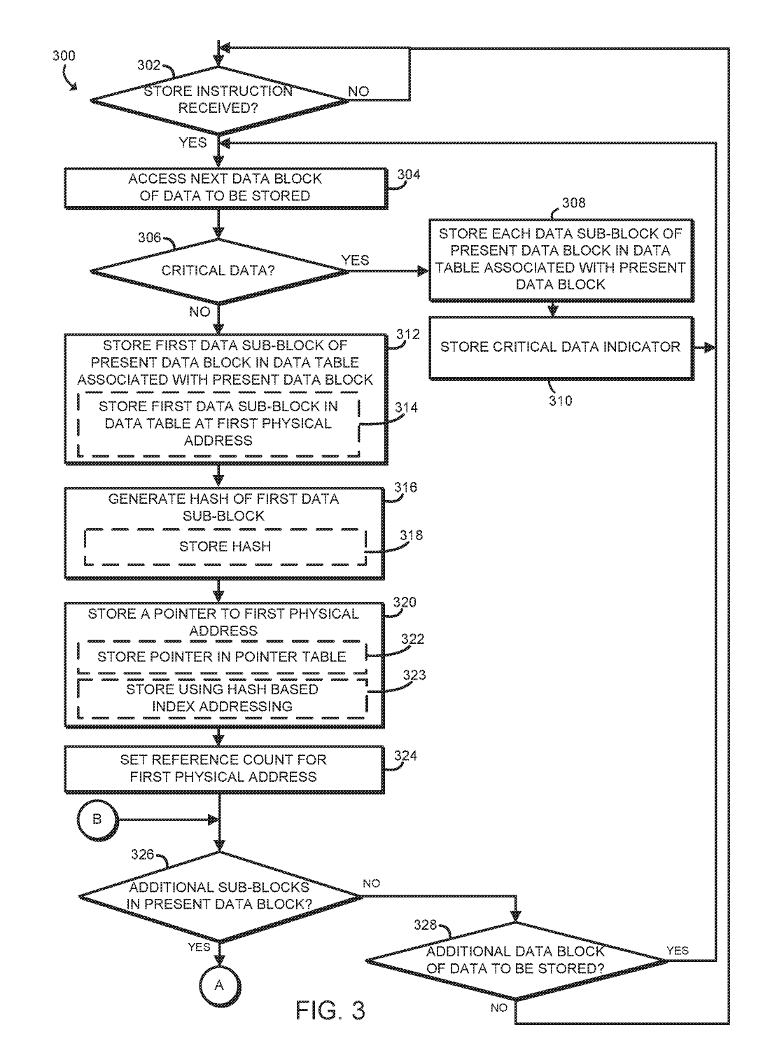

Referring now to FIG. 3, in use, the data storage controller 102 of the data storage device 100 may execute a method 300 for performing a data deduplication operation. The method begins at block 302 in which the data storage controller 102 determines whether a store instruction has been received from the host 222. If so, the method 300 advances to block 304 in which the data storage controller 102 accesses the next data block (e.g., the first data block) of the data to be stored. For example, the data storage controller 102 may access the next data block by reading the data block from an address specified in the store instruction received by interface module 212. To do so, in some embodiments, the host interface 108 temporarily stores the data block at an address in the buffer 112 and transmits the address to the memory control logic 114. In block 306, the data storage controller 102 determines whether the data block accessed in block 304 is critical data. For example, in some embodiments, the store instruction received in block 302 may include a parameter, such as an indicator or flag, that indicates that each data sub-block within the accessed data block is to be stored to the data storage table 218, regardless of whether any of the sub-blocks of that data block are duplicates of other sub-blocks. In other implementations, the data storage controller 102 may determine that the data block is critical data based on another factor, such as the identity of the application (i.e., the host 222) that transmitted the storage instruction and/or a time when the storage instruction was transmitted (e.g., a scheduled backup).

If the data storage controller 102 determines that the present data block is critical data, the method 300 advances to block 308 in which the data storage controller 102 stores each data sub-block of the present data block in the data table 218 associated with the present data block. Subsequently, in block 310, the data storage controller 102 stores a critical data indicator in the memory 116 indicating that the data block is critical data. In some embodiments, data storage controller 102 may store the critical data indicator in association with each sub-block of the present data block. The method 300 subsequently loops back to block 304 in which the data storage controller 102 accesses the next data block of the data to be stored.

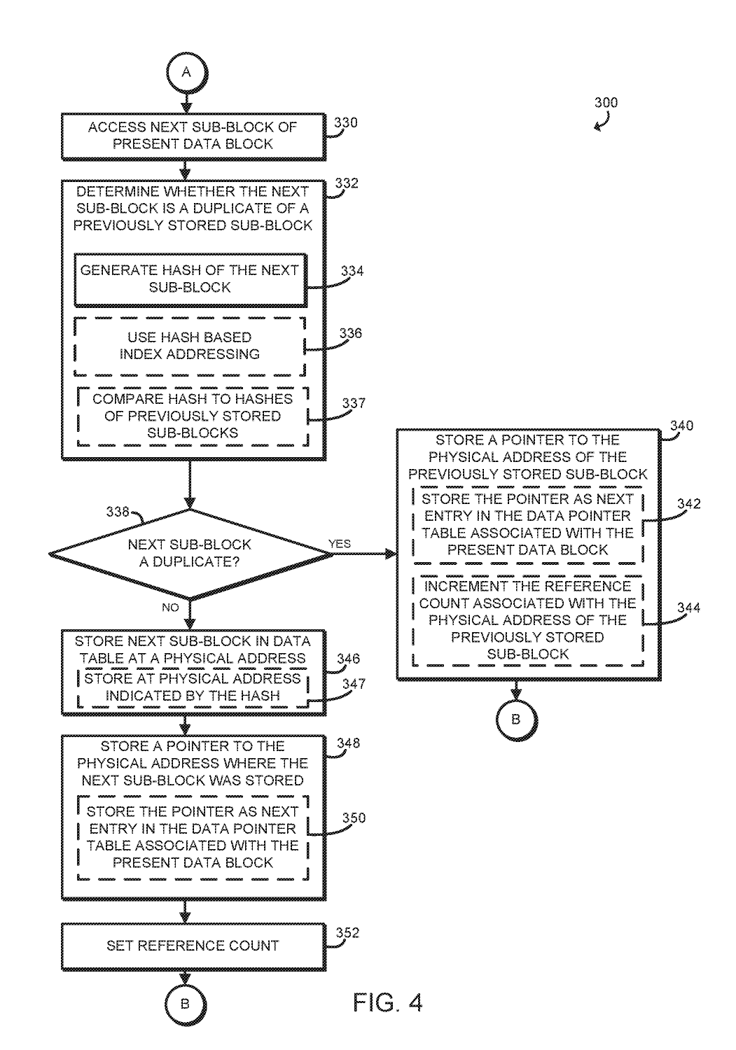

If, however, the data storage controller 102 determines that the present data block is not critical data, the method 300 advances to block 312. In embodiments that determine whether data sub-blocks are duplicates of any other data sub-blocks stored anywhere in the data table, rather than with respect to only the other sub-blocks within a particular data block, the method skips to block 330 of FIG. 4, in which the present sub-block is treated as the next sub-block to be analyzed for deduplication. Otherwise, in block 312, the data storage controller 102 stores a first data sub-block of the present data block in a data table 218 associated with the present data block. To do so, the data storage controller 102 may store the first data sub-block in the data table 218 at a first physical address in block 314. In the illustrative embodiment, a single data table 218 stores all data blocks (e.g., a global data table 218). However, in some embodiments, the memory 116 may include multiple data tables 218, each assigned to a different data block.

In block 316, the data storage controller 102 generates a hash 216 of the first data sub-block. As described above, the hash 216 may be embodied as set of values that represent the contents of the first data sub-block. The data storage controller 102 may utilize any suitable hash algorithm to generate the hashes. Additionally, in some embodiments, the data storage controller 102 stores the generated hash (e.g., in the memory 116) in block 318.

In block 320, the data storage controller 102 stores a pointer, in a data pointer table 214, to the first physical address at which the sub-block was stored. For example, as shown in block 322, the data storage controller 102 may store the pointer in a first entry in the data pointer table 214 associated with the present data block. In some embodiments, the data storage controller 102 stores the pointer in accordance with the hash based index addressing method described above, such that the hash 216 is the pointer, and acts as an address range in which the data sub-block was stored. Additionally, in block 324, the data storage controller 102 sets the reference count 220 for the first physical address to one. That is, because the present data sub-block is the first data sub-block of the present data block, no duplicates of the data sub-block have been detected yet. Accordingly, only one pointer in the data pointer table points to the physical address at which the data sub-block was stored.

Subsequently, in block 326, the data storage controller 102 determines whether additional data sub-blocks remain in the present data block to be stored. If no additional data sub-blocks remain, the method 300 advances to block 328 in which the data storage controller 102 determines whether another data block of the data to be stored remains. For example, another data block may be present in the buffer 112 for storage in the memory 116. If there are additional data blocks of the present data to be stored, the method 300 loops back to block 304 in which the data storage controller 102 accesses the next data block of the data to be stored. If, however, no additional data blocks remains, the method 300 loops back to block 302 in which the data storage controller 102 monitors for another store instruction.

Returning back to block 326, if the data storage controller 102 determines that additional sub-blocks remain in the present data block, the method 300 advances to block 330 of FIG. 4. In block 330, the data storage controller 102 accesses the next sub-block of the present data block to be stored. Subsequently, in block 332, the data storage controller 102 determines whether the next sub-block is a duplicate of a previously stored sub-block. To do so, in block 354, the data storage controller 102 generates a hash 216 of the next sub-block. Again, the data storage controller 102 may utilize any suitable hash algorithm to generate the hash as discussed above. In some embodiments, as indicated in block 336, the data storage controller 102 may use the hash based index addressing method to determine whether the next sub-block is a duplicate of previously stored sub-block. In embodiments in which the data storage controller 102 uses hash based index addressing, the data storage controller 102 may determine that the next sub-block is not a duplicate of a previously-stored sub-block if the reference count associated with the address range that the hash 216 points to is zero. However, if the reference count is greater than zero, then the data storage controller 102 determines which, if any, of the previously stored sub-blocks stored in the various entries at the address contains identical data to the data sub-block to be stored, by performing a bit-by-bit or byte-by-byte comparison. If the data storage controller 102 finds a match, then the next data sub-block is a duplicate of a previously-stored data sub-block. As indicated in block 337, in other embodiments that do not use hash based address indexing, the data storage controller 102 may compare the hash 216 of the next sub-block to the hash of each previously stored sub-block of the present data block. To do so, the data storage controller 102 may compare the hashes in any suitable manner (e.g., a bit-by-bit comparison). In such embodiments, the data storage controller 102 may then determine whether a sub-block is a duplicate of another sub-block by performing a byte-by-byte or bit-by-bit comparison of the sub-blocks after confirming that their hashes are identical. In block 338, the data storage controller 102 checks the result of the analysis performed in block 332, representing whether the next sub-block is a duplicate.

If the next sub-block is a duplicate, the method 300 advances to block 340. In block 340, the data storage controller 102 stores a pointer to the physical address of the previously stored data sub-block. For example, in the illustrative embodiment, the data storage controller 102 stores the pointer as the next entry in the data pointer table 214 associated with the present data block in block 342. Additionally, in the illustrative embodiment, the data storage controller 102 increments the reference count 220 associated with the physical address of the previously-stored data sub-block in block 344. Accordingly, the incremented reference count indicates that an additional pointer in the data pointer table 214 associated with the present data block now points to the physical address. The method 300 subsequently loops back to block 326 of FIG. 3 in which the data storage controller 102 determines whether any additional data sub-blocks remain in the present data block.

Referring back to block 338, if the data storage controller 102 determines that the next data sub-block is not a duplicate of a previously stored data sub-block, the method 300 advances to block 346. In block 346, the data storage controller 102 stores the next sub-block at an unused physical address in the data table 218. An unused physical address in the data table 218 may be embodied as a physical address that has no reference count, or that has a reference count of zero associated with it. In embodiments in which the data storage controller 102 uses the hash based index addressing method described above, the data storage controller 102 may store the next data sub-block in an entry in the physical address range indicated by the hash. Subsequently, in block 348, the data storage controller 102 stores a pointer to the next physical address at which the next sub-block was stored. For example, in block 350, the data storage controller 102 stores the pointer as the next entry in the data pointer table 214 associated with the present data block. In embodiments that use hash based index addressing, the data storage controller 102 may additionally store an indicator with the pointer. The indicator may indicate the entry in the physical address range that contains the data sub-block. Regardless, in block 352, the data storage controller 102 sets the reference count 220 associated with the physical address at which the data sub-block was stored. For example, the reference count management module 210 may set the reference count to one. The method 300 subsequently loops back to block 326 of FIG. 3 in which the data storage controller 102 determines whether any additional data sub-blocks remain in the present data block. It should be appreciated that although the deduplication operation of method 300 has been described above in regard to the storage of data, the deduplication operation described above in regard to method 300 may be performed at other times such as in a deferred deduplication or garbage collection process.

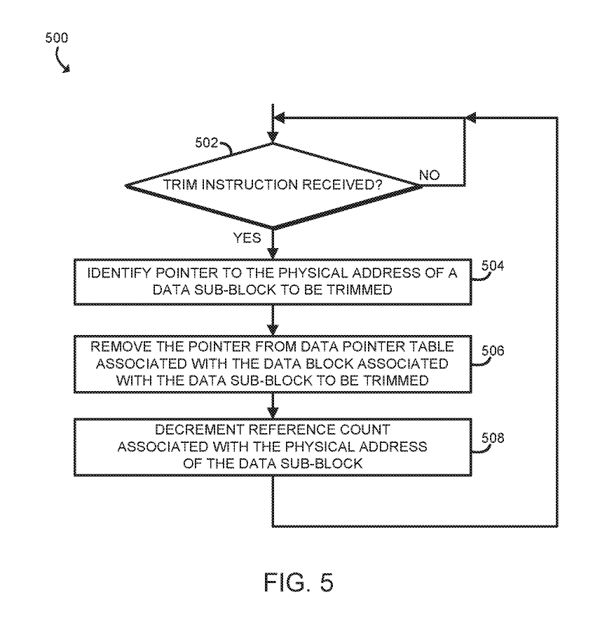

Referring now to FIG. 5, in use, the data storage controller 102 of the data storage device 100 may execute a method 500 for trimming data from the memory 116. More specifically, a trim operation is used in solid state drives to identify which blocks of data are no longer in use. Accordingly, when subsequently writing a page, the solid state drive does not preserve the contents of the block. Compared to conventional delete operations, trim operations enable higher write speeds and increased longevity for solid state drives. The method 500 begins with block 502 in which the data storage controller 102 determines whether a trim instruction has been received (e.g., from the host 222). If so, the method 500 advances to block 504 in which the data storage controller 102 identifies a pointer to the physical address of a data sub-block of the data to be trimmed. For example, in some embodiments, the trim instruction may specify a data sub-block(s) to be trimmed, for example an index (i.e., address) into a data pointer table 214 associated with the data sub-block to be trimmed. The data storage controller 102 reads the pointer to obtain the physical address in the data table 218 at which the data sub-block is stored. In block 506, the data storage controller 102 removes the pointer from the data pointer table 214. Additionally, at block 508, the data storage controller 102 decrements the reference count 220 associated with the physical address of the data sub-block to be trimmed The method 500 subsequently loops back to block 502 in which the data storage controller 102 monitors for additional trimming instructions.

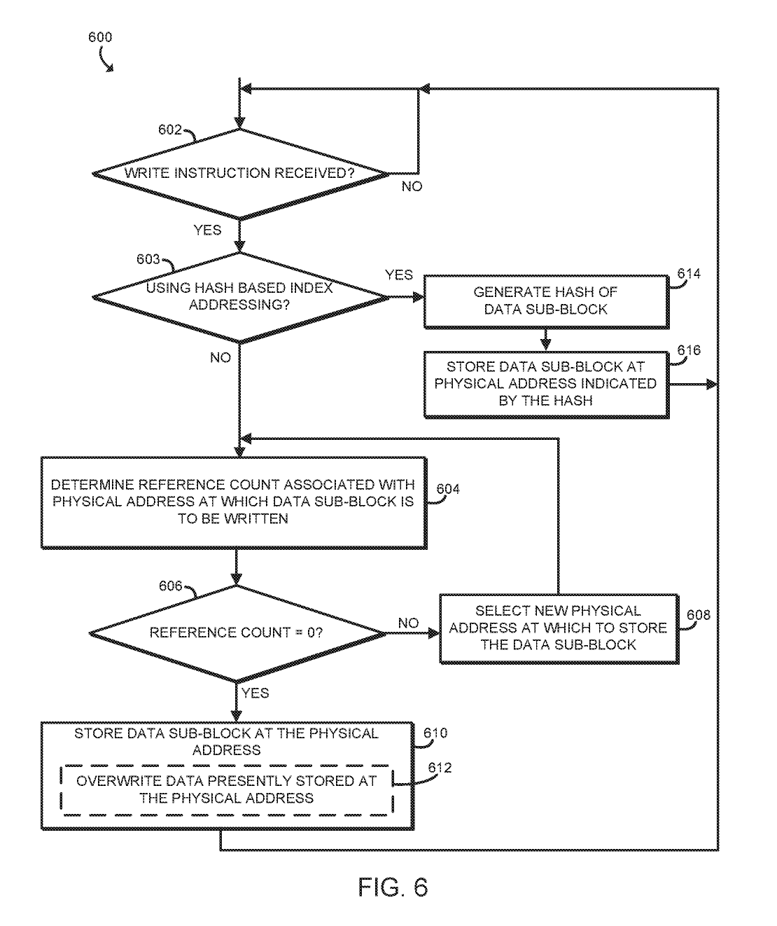

Referring now to FIG. 6, in use, the data storage controller 102 of the data storage device 100 may execute a method 600 of writing data to the memory 116. The method 600 begins with block 602 in which the data storage controller 102 determines whether a write instruction has been received (e.g., from the host 222). If so, the method 600 advances to block 603 in which the data storage controller 102 proceeds down one of two paths, depending on whether the data storage controller 102 is configured to use hash based address indexing or not. If the data storage controller 102 not configured to use hash based address indexing, the method 600 advances to block 604 in which the data storage controller 102 determines the reference count 220 associated with the physical address at which a data sub-block is to be written. Subsequently, in block 606, the data storage controller determines whether the reference count 220 is equal to zero. If the reference count 220 is not equal to zero, the data storage controller 102 advances to block 608 in which the data storage controller 102 selects a new physical address at which to store the data sub-block. In some embodiments, the data storage controller 102 may select the next physical address in the data table 218, for example by increasing the physical address by the size of a data sub-block (e.g., 64 bytes). In other embodiments, the data storage controller 102 may select the next physical address by another methodology, for example by randomly selecting another physical address. Regardless, after the data storage controller 102 has selected the next physical address in block 608, the method 600 loops back to block 604 in which the data storage controller determines the reference count for the newly selected physical address. Referring back to block 603, if the data storage controller 102 is configured to use hash based address indexing, the method advances to block 614 in which the data storage controller 102 generates a hash of the data sub-block. Subsequently, in block 616, the data storage controller 102 stores the data sub-block at the physical address indicated by the hash, in accordance with the hash based index addressing method. More specifically, the hash acts as the physical address range where the data sub-block is to be stored. In at least some embodiments, the data storage controller 102 stores the data sub-block in one of various entries in the physical address range, such as an unused entry having a reference count of zero. Further, in such embodiments, the data storage controller 102 stores an indicator in the data pointer table indicating which entry in the physical address range the data sub-block was stored at.

Referring back to block 606, if the data storage controller 102 determines that the reference count of the presently selected physical address is zero (or undefined), the method 600 advances to block 610. In block 610, the data storage controller 102 stores the data sub-block at the presently selected physical address. To do so, in some embodiments, the data storage controller 102 may overwrite data that is presently stored at the physical address. For example, the physical address may include a previously-stored data sub-block that is no longer referenced by any pointers in a data pointer table 214. After the data storage controller 102 has stored the data sub-block, the method 600 loops back to block 602 in which the data storage controller 102 monitors for another write instruction (e.g., a write instruction associated with another data sub-block of a data block to be written to the memory 116).

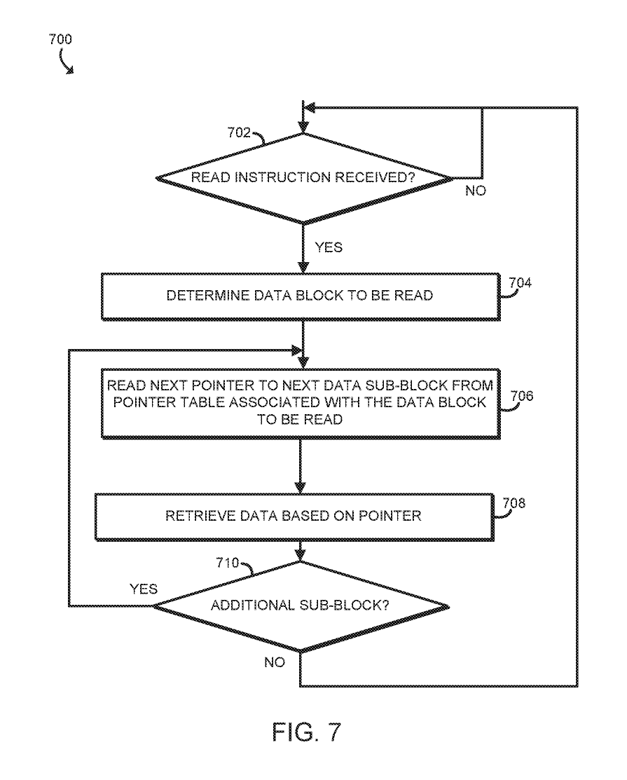

Referring now to FIG. 7, in use, the data storage controller 102 of the data storage device 100 may execute a method 700 of reading data from the memory 116. The method 700 begins with block 702 in which the data storage controller 102 determines whether a read instruction has been received (e.g., from host 222). If a read instruction has been received, the method 700 advances to block 704 in which the data storage controller 102 determines the data block to be read. For example, the read instruction may include an address of a data pointer table 214 associated with the data block to be read. Subsequently, in block 706, the data storage controller 102 reads the next pointer to the next data sub-block from the data pointer table 214 associated with the data block to be read. In block 708, the data storage controller 102 retrieves the data (i.e., data sub-block) from the data table 218 based on the pointer. That is, the data storage controller 102 retrieves the data sub-block stored at the physical address pointed to by the pointer. In embodiments that use hash based index addressing, the data storage controller 102 may retrieve the data sub-block at one of various entries at the physical address range pointed to by the pointer. In such embodiments, the pointer in the data pointer table may be stored with an indicator that indicates which entry in the physical address range actually contains the data sub-block and the data storage controller 102 retrieves the data sub-block from that entry. Subsequently, in block 710, the data storage controller 102 determines whether an additional sub-block is to be read. For example, the data storage controller 102 may determine whether the data pointer table 214 includes an additional entry with another pointer to a physical address. If not, the method 700 loops back to block 702 in which the data storage controller 102 continues to monitor for additional read instructions. If, however, an additional data sub-block is to be read, the method 700 loops back to block 706 in which the data storage controller 102 reads the next pointer to the next data sub-block from the data pointer table 214.

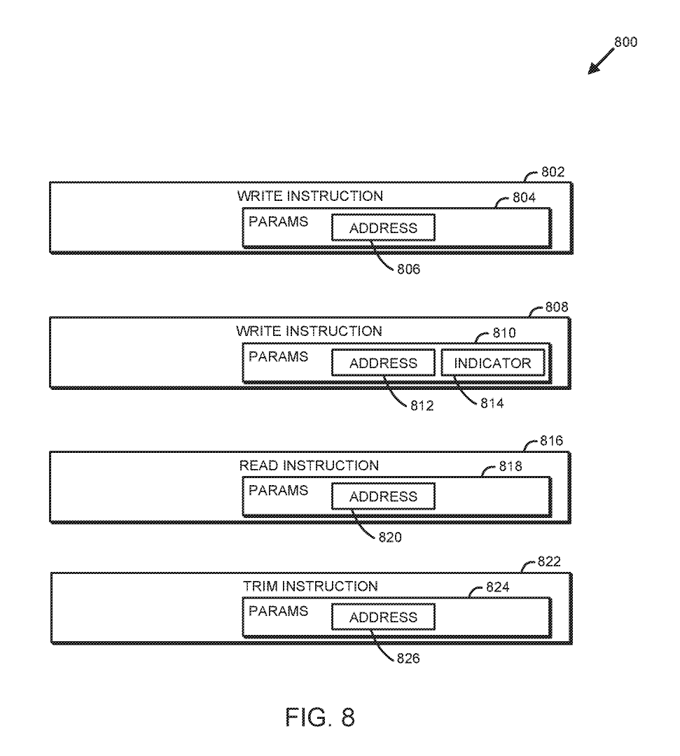

Referring now to FIG. 8, during operation, the data storage device 100 may receive a variety of instructions 800 (e.g., from the host 222). For example, the data storage device 100 may receive a write instruction 802. The illustrative write instruction 802 includes parameters 804, which include as an address 806 (e.g., an address in memory) of a data block to write to the memory 116. Additionally or alternatively, the data storage device 100 may receive a write instruction 808. The illustrative write instruction 808 includes parameters 810, which include an address 812 of a data block to write to memory 116 and an indicator 814 that indicates that the data to be written is critical data. As described above, in some embodiments, the data storage device 100 stores each sub-block of critical data without using the deduplication operation described herein. Additionally or alternatively, the data storage device 100 may also receive a read instruction 816 that includes parameters 818. The parameters 818 include, for example, an address 820 of a data block to be read. For example, the address 820 may specify a data pointer table 214 that the data storage controller 102 traverses in order to access the corresponding data sub-blocks and reconstruct the data block. Additionally or alternatively, the data storage device 100 may receive a trim instruction 822 that includes parameters 824. The parameters 824 include, for example, an address of a data block or a data sub-block to be trimmed from the memory 116.

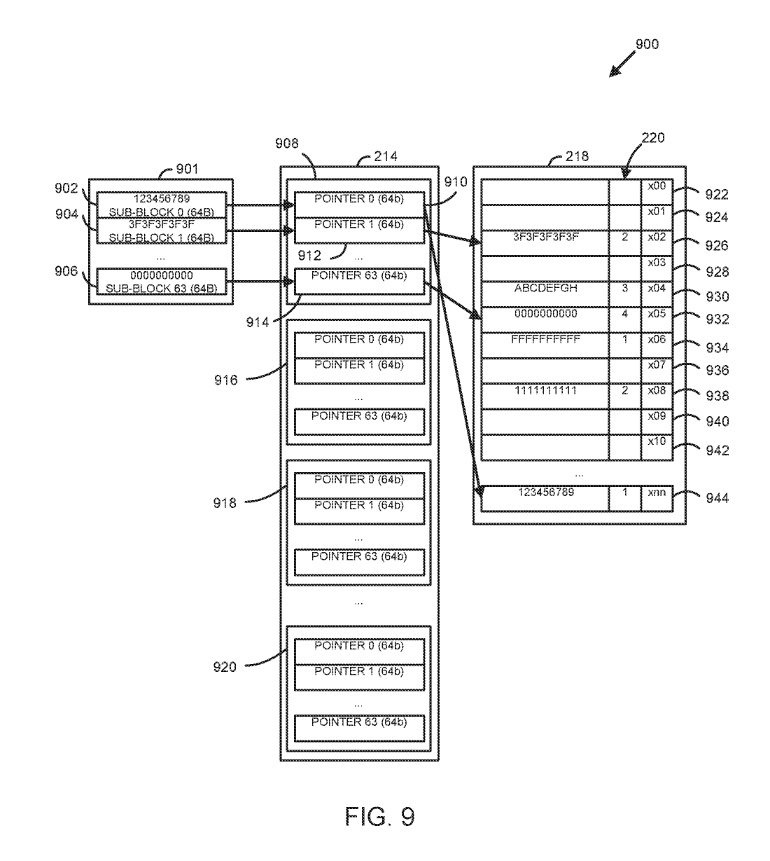

Referring now to FIG. 9, a block diagram 900 illustrates an embodiment of the storage of data by the data storage device 100. In the illustrative embodiment, the data storage controller 102 obtains a data block 901 to be stored to the memory 116. For example, in some embodiments, the data storage controller 102 may read the data block 901 from buffer 112. The data block 901 includes a plurality of data sub-blocks. In the illustrative embodiment, the data block 901 includes 64 data sub-blocks. Illustratively, a first data sub-block 902, a second data sub-block 904, and a 64^{th} data sub-block 906 are shown. Each data sub-block in the data block 901 contains 64 bytes of data. In other embodiments, the number of sub-blocks in a data block and the number of bytes of data in a sub-block may differ. The memory 116 includes a plurality of data pointer tables 214, including a first data pointer table 908, a second data pointer table 916, a third data pointer table 918, and an Nth data pointer table 920. Each pointer table is associated with a respective data block. Furthermore, each data pointer table, for example data pointer table 908, includes a plurality of entries at which respective pointers are stored. For example, block diagram 900 shows a first pointer 910 that is associated with sub-block 902, a second pointer 912 that is associated with sub-block 904, and a 64^{th} pointer 914 associated with sub-block 906. It should be understood that the data pointer table 908 also includes pointers for the third through the sixty-third data sub-blocks. Moreover, in the illustrative embodiment, the entries containing the pointers are stored sequentially, such that the pointer 910 associated with the first data sub-block 902 is located in the first entry in the data pointer table 908, the pointer 912 associated with the second data sub-block 904 is located in the second entry in the data pointer table, and so on.

Each pointer in the data pointer table 908 points to one of the physical addresses, for example one of physical addresses 922, 924, 926, 928, 930, 932, 934, 936, 938, 940, 942, and 944, in the data table 218 where the data sub-blocks are stored. In at least some embodiments, while the pointers in a particular data table are stored in sequence, the data sub-blocks in the data table 218 are not necessarily stored in sequence. The physical addresses at which the data sub-blocks are stored have reference counts 220 associated therewith, as described above. While the reference counts 220 are shown adjacent to the data of each sub-block in FIG. 9, it should be understood that in at least some embodiments, the reference counts 220 are stored in a separate area in the memory 116. Further, while the data pointer table 908 is shown with pointers pointing into the data in the data table 218, it should be understood that in at least some embodiments, data pointer tables 916, 918, and 920 may also include pointers that point to data sub-blocks in the data table 218.

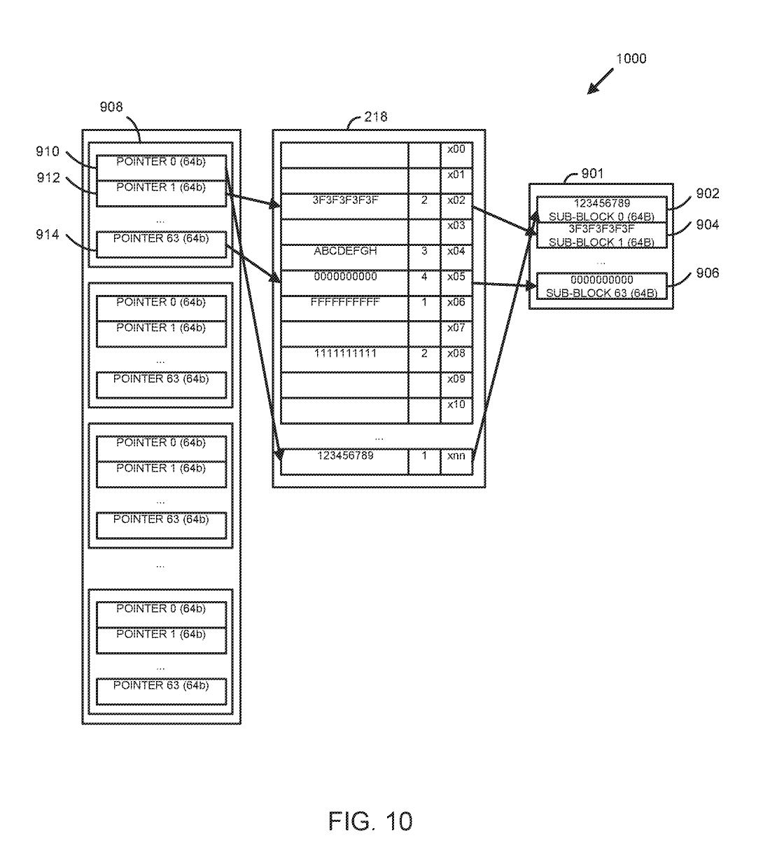

Referring now to FIG. 10, a block diagram 1000 illustrates an embodiment of the reconstruction of data by the data storage device 100. As discussed above, in order to read a data block (e.g., data block 901), the data storage controller 102 accesses the data pointer table 908 associated with the data block to be read (e.g., data block 901). For example, the data storage controller 102 may receive a read instruction (e.g., read instruction 816) that includes address 820. The data storage controller 102 accesses the data pointer table 908 which is located in memory 116 at the address 820. Next, data storage controller 102 sequentially reads each pointer (e.g., first pointer 910, second pointer 912, through 64^{th} pointer 914), reads the data sub-block at each corresponding physical address in the data table 218, and reassembles the data block (e.g., data block 901), for example by concatenating the data sub-blocks as they are read. In some embodiments, the data storage controller 102 stores the reassembled data block 901 in buffer 112 to be provided to the host 222 in response to the read instruction.

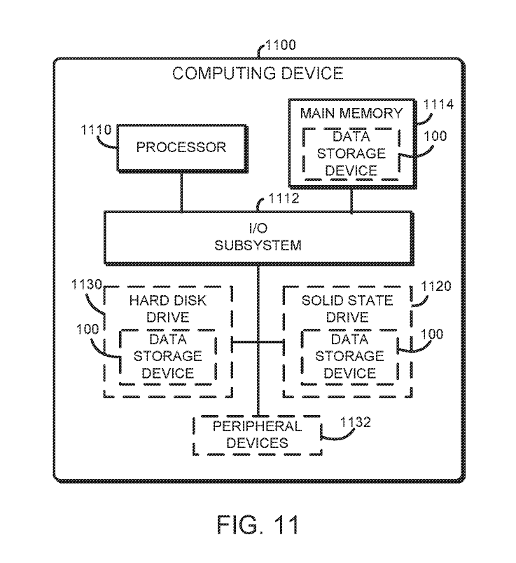

Referring now to FIG. 11, in some embodiments, the data storage device 100 may be incorporated in, or form a portion of, a computing device 1100. The computing device 1100 may be embodied as any type of computing device in which the data storage device 100 may be used. For example, the computing device 1100 may be embodied as a smart phone, a tablet computer, a notebook, a laptop computer, a netbook, an Ultrabook™, a wearable computing device, a pair of smart glasses, a head-mounted computing device, a cellular phone, a desktop computer, a smart device, a personal digital assistant, a mobile Internet device, a server, a data storage device, and/or any other computing/communication device. As shown in FIG. 11, the illustrative computing device 1100 includes a processor 1110, an input/output (“I/O”) subsystem 1112, and a main memory 1114. Of course, the computing device 1100 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. For example, the memory 1114, or portions thereof, may be incorporated in the processor 1110 in some embodiments.

The processor 1110 may be embodied as any type of processor capable of performing the functions described herein. For example, the processor 1110 may be embodied as a single or multi-core processor(s), digital signal processor, microcontroller, or other processor or processing/controlling circuit. Similarly, the memory 1114 may be embodied as any type of volatile or non-volatile memory or data storage capable of performing the functions described herein. In operation, the memory 1114 may store various data and software used during operation of the computing device 1100 such as operating systems, applications, programs, libraries, and drivers. The memory 1114 is communicatively coupled to the processor 1110 via the I/O subsystem 1112, which may be embodied as circuitry and/or components to facilitate input/output operations with the processor 1110, the memory 1114, and other components of the computing device 1100. For example, the I/O subsystem 1112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

As shown in FIG. 11, the data storage device 100 may be incorporated in, or form a portion of, one or more other components of the computing device 1100. For example, the data storage device 100 may be embodied as, or otherwise be included in, the main memory 1114. Additionally or alternatively, the data storage device 100 may be embodied as, or otherwise included in, a solid state drive 1120 of the computing device 1100. Further, in some embodiments, the data storage device 100 may be embodied as, or otherwise included in, a hard disk drive 1130 of the computing device 1100. Of course, in other embodiments, the data storage device 100 may be included in or form a portion of other components of the computing device 1100.

Reference to memory devices can apply to different memory types, and in particular, any memory that has a bank group architecture. Memory devices generally refer to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR4 (DDR version 4, initial specification published in September 2012 by JEDEC), DDR4E (in development by JEDEC), LPDDR4 (LOW POWER DOUBLE DATA RATE (LPDDR) version 4, JESD209-4, originally published by JEDEC in August 2014), WIO2 (Wide I/O2 (WideIO2), JESD229-2, originally published by JEDEC in August 2014), HBM (HIGH BANDWIDTH MEMORY DRAM, JESD235, originally published by JEDEC in October 2013), DDRS (DDR version 5, currently in discussion by JEDEC), LPDDRS (currently in discussion by JEDEC), HBM2 (HBM version 2), currently in discussion by JEDEC), and/or others, and technologies based on derivatives or extensions of such specifications.

In addition to, or alternatively to, volatile memory, in one embodiment, reference to memory devices can refer to a nonvolatile memory device whose state is determinate even if power is interrupted to the device.

### EXAMPLES

Illustrative examples of the technologies disclosed herein are provided below. An embodiment of the technologies may include any one or more, and any combination of, the examples described below.

Example 1 includes an apparatus comprising a memory to store data blocks of data and a pointer table, wherein the pointer table is to store one or more pointers and each pointer points to a physical address of the memory; and a controller to manage the storage of a data block to the memory, wherein the data block comprises a plurality of data sub-blocks and the controller is to store a first data sub-block of the plurality of data sub-blocks in the memory at a first physical address; store a pointer that points to the first physical address of the memory in the pointer table; determine whether a second data sub-block of the plurality of data sub-blocks is a duplicate of the first data sub-block; and store, in response to a determination that the second data sub-block is a duplicate of the first data sub-block, a second pointer in the pointer table, wherein the second pointer points to the first physical address.

Example 2 includes the subject matter of Example 1, and wherein the memory is further to store reference counts associated with physical addresses of the memory; and the controller is further to set the reference count associated with the first physical address after the first pointer is stored; and increment the reference count associated with the first physical address after the second pointer is stored.

Example 3 includes the subject matter of Examples 1 and 2, and wherein the controller is further to generate a hash of each data sub-block and store each hash in the memory as a pointer to the respective data sub-block.

Example 4 includes the subject matter of Examples 1-3, and wherein the controller is further to compare a first hash generated from the first data sub-block to a second hash generated from the second data sub-block to determine whether the second data sub-block is a duplicate of the first data sub-block.

Example 5 includes the subject matter of Examples 1-4, and wherein the memory is further to store reference counts associated with physical addresses of the memory; and the controller is further to remove the second pointer from the first pointer table; and decrement a reference count associated with the first physical address after the second pointer is removed.

Example 6 includes the subject matter of Examples 1-5, and wherein the memory is further to store reference counts associated with physical addresses of the memory; and the controller is further to determine that a reference count associated with the first physical address is equal to zero; and overwrite the first data sub-block in response to the determination that the reference count is equal to zero.

Example 7 includes the subject matter of Examples 1-6, and wherein the controller is further to store a second data block that includes a second plurality of data sub-blocks in the memory; and store a plurality of pointers to physical addresses of the memory corresponding to the stored second plurality of data sub-blocks.

Example 8 includes the subject matter of Examples 1-7, and wherein the controller is further to sequentially read each pointer in the pointer table; and retrieve each respective data sub-block from the memory.

Example 9 includes the subject matter of Examples 1-9, and wherein the controller is further to store the second data sub-block in the memory at a second physical address at a first time; determine, at a second time that is subsequent to the first time, whether the second data sub-block is a duplicate of the first data sub-block; and set, in response to a determination that the second data sub-block is a duplicate of the first data sub-block, the second pointer to point to the first physical address in the memory.

Example 10 includes the subject matter of Examples 1-9, and wherein controller is further to receive an instruction to store a second data block, wherein the instruction includes a parameter that indicates the second data block is critical data; store the parameter in a second pointer table that is associated with the second data block; and store each data sub-block of a plurality of data sub-blocks included in the second data block at a respective different physical address in the memory.

Example 11 includes the subject matter of Examples 1-10, and further including one or more of at least one processor communicatively coupled to the memory, a network interface communicatively coupled to a processor, a display communicatively coupled to a processor, or a battery coupled to the apparatus.

Example 12 includes the subject matter of Examples 1-11, and wherein the data block is a 4 kilobyte data block and the controller is further to store the pointers as 64 bit pointers; and store the data sub-blocks as 64 byte data sub-blocks.

Example 13 includes the subject matter of Examples 1-12, and wherein the controller is further to receive an instruction from a host to read the data block; sequentially read each pointer in the pointer table; retrieve each respective data sub-block from the memory; and concatenate each data sub-block in a buffer for transmission of the data block to the host.

Example 14 includes the subject matter of Examples 1-13, and wherein the controller is further to receive a write instruction from a host to write the data block; and store, in response to the write instruction, the data sub-blocks.

Example 15 includes the subject matter of Examples 1-14, and wherein the controller is further to receive a trim instruction from a host to trim the data block; remove, in response to the trim instruction, the pointers associated with the data sub-blocks of the data block from the pointer table; and decrement reference counts associated with each data sub-block of the data block.

Example 16 includes the subject matter of Examples 1-15, and wherein the memory includes a plurality of non-volatile memory devices.

Example 17 includes the subject matter of Examples 1-16, and wherein the memory includes a plurality of non-volatile byte-addressable write-in-place memory devices.

Example 18 includes the subject matter of Examples 1-17, and wherein the controller is further to perform a byte-by-byte comparison of the second data block to the first data sub-block to determine whether the second data sub-block is a duplicate of the first data sub-block.

Example 19 includes the subject matter of Examples 1-18, and wherein the controller is further to generate a hash of each data sub-block; and store each hash in the memory.

Example 20 includes the subject matter of Examples 1-19, and wherein the controller is further to perform a bit-by-bit comparison of the second data block to the first data sub-block to determine whether the second data sub-block is a duplicate of the first data sub-block.

Example 21 includes the subject matter of Examples 1-20, and wherein the controller is further to store reference counts associated with physical addresses of the plurality of data sub-blocks in a table in the memory.

Example 22 includes a method comprising storing, by a controller of an apparatus, a first data sub-block of a plurality of data sub-blocks of a data block in a memory of the apparatus at a first physical address; storing, by the controller, a pointer that points to the first physical address of the memory in a pointer table; determining, by the controller, whether a second data sub-block of the plurality of data sub-blocks is a duplicate of the first data sub-block; and storing, by the controller and in response to a determination that the second data sub-block is a duplicate of the first data sub-block, a second pointer in the pointer table, wherein the second pointer points to the first physical address.

Example 23 includes subject matter of Example 22, and further including setting, by the controller, a reference count associated with the first physical address after the first pointer is stored; and incrementing, by the controller, the reference count associated with the first physical address after the second pointer is stored.

Example 24 includes the subject matter of Examples 22 and 23, and further including generating, by the controller, a hash of each data sub-block as a pointer to the respective data sub-block.

Example 25 includes the subject matter of Examples 22-24, and further including determining, by the controller, that the second data sub-block is a duplicate of the first data sub-block by comparing a first hash generated from the first data sub-block to a second hash generated from the second data sub-block.

Example 26 includes the subject matter of Examples 22-25, and further including removing, by the controller, the second pointer from the first pointer table; and decrementing, by the controller, a reference count associated with the first physical address after the second pointer is removed.

Example 27 includes the subject matter of Examples 22-26, and further including determining, by the controller, that a reference count associated with the first physical address is equal to zero; and overwriting, by the controller, the first data sub-block in response to determining that the reference count is equal to zero.

Example 28 includes the subject matter of Examples 22-27, and further including storing, by the controller, a second data block that includes a second plurality of data sub-blocks in the memory; and storing, by the controller, a plurality of pointers to physical addresses of the memory corresponding to the stored second plurality of data sub-blocks.

Example 29 includes the subject matter of Examples 22-28, and further including sequentially reading, by the controller, each pointer in the pointer table; and retrieving, by the controller, each respective data sub-block from the memory.

Example 30 includes the subject matter of Examples 22-29, and further including storing, by the controller, the second data sub-block in the memory at a second physical address at a first time; and determining, by the controller and at a second time that is subsequent to the first time, whether the second data sub-block is a duplicate of the first data sub-block; and setting, by the controller and in response to a determination that the second data sub-block is a duplicate of the first data sub-block, the second pointer to point to the first physical address in the memory.

Example 31 includes the subject matter of Examples 22-30, and further including receiving, by the controller, an instruction to store a second data block, wherein the instruction includes a parameter that indicates the second data block is critical data; storing, by the controller, the parameter in a second pointer table that is associated with the second data block; and storing, by the controller, each data sub-block of a plurality of data sub-blocks included in the second data block at a respective different physical address in the memory.

Example 32 includes the subject matter of Examples 22-31, and further including storing, by the controller, at least the second pointer using a base-delta format.

Example 33 includes the subject matter of Examples 22-32, and wherein storing the first data sub-block further comprises storing a 64 byte first data sub-block; and storing the first pointer further comprises storing a 64 bit pointer.

Example 34 includes the subject matter of Examples 22-33, and further including receiving, by the controller, an instruction from a host to read the data block; sequentially reading, by the controller, each pointer in the pointer table; retrieving, by the controller, each respective data sub-block from the memory; and concatenating, by the controller, each data sub-block in a buffer for transmission of the data block to the host.

Example 35 includes the subject matter of Examples 22-34, and further including receiving, by the controller, a write instruction from a host to write the data block; and storing, by the controller and in response to the write instruction, the data sub-blocks.

Example 36 includes the subject matter of Examples 22-35, and further including receiving, by the controller, a trim instruction from a host to trim the data block; removing, by the controller and in response to the trim instruction, the pointers associated with the data sub-blocks of the data block from the pointer table; and decrementing, by the controller, reference counts associated with each data sub-block of the data block.

Example 37 includes the subject matter of Examples 22-36, and wherein storing the first data sub-block further comprises storing the first data sub-block to one of a plurality of non-volatile data storage devices included in the memory.

Example 38 includes the subject matter of Examples 22-37, and wherein storing the first data sub-block further comprises storing the first data sub-block to one of a plurality of non-volatile byte-addressable write-in-place data storage devices included in the memory.

Example 39 includes the subject matter of Examples 22-38, and further including generating, by the controller, a hash of each data sub-block; and storing, by the controller, each hash in the memory.

Example 40 includes the subject matter of Examples 22-39, and further including performing, by the controller, a bit-by-bit comparison of the second data block to the first data sub-block to determine whether the second data sub-block is a duplicate of the first data sub-block.

Example 41 includes the subject matter of Examples 22-40, and further including storing, by the controller, reference counts associated with physical addresses of the plurality of data sub-blocks in a table in the memory.

Example 42 includes one or more machine-readable storage media comprising a plurality of instructions stored thereon that, when executed, cause an apparatus to perform the method of any of Examples 22-41.

Example 43 includes an apparatus comprising means for storing a first data sub-block of a plurality of data sub-blocks of a data block in a memory of the apparatus at a first physical address; means for storing a pointer that points to the first physical address of the memory in a pointer table; means for determining whether a second data sub-block of the plurality of data sub-blocks is a duplicate of the first data sub-block; and means for storing, in response to a determination that the second data sub-block is a duplicate of the first data sub-block, a second pointer in the pointer table, wherein the second pointer points to the first physical address.

Example 44 includes the subject matter of Example 43, and further including means for setting a reference count associated with the first physical address after the first pointer is stored; and means for incrementing the reference count associated with the first physical address after the second pointer is stored.

Example 45 includes the subject matter of Examples 43 and 44, and further including means for generating a hash of each data sub-block as a pointer to the respective data sub-block.

Example 46 includes the subject matter of Examples 43-45, and further including means for determining that the second data sub-block is a duplicate of the first data sub-block by comparing a first hash generated from the first data sub-block to a second hash generated from the second data sub-block.

Example 47 includes the subject matter of Examples 43-46, and further including means for removing the second pointer from the first pointer table; and means for decrementing a reference count associated with the first physical address after the second pointer is removed.

Example 48 includes the subject matter of Examples 43-47, and further including means for determining that a reference count associated with the first physical address is equal to zero; and means for overwriting the first data sub-block in response to determining that the reference count is equal to zero.

Example 49 includes the subject matter of Examples 43-48, and further including means for storing a second data block that includes a second plurality of data sub-blocks in the memory; and means for storing a plurality of pointers to physical addresses of the memory corresponding to the stored second plurality of data sub-blocks.

Example 50 includes the subject matter of Examples 43-49, and further including means for sequentially reading each pointer in the pointer table; and means for retrieving each respective data sub-block from the memory.

Example 51 includes the subject matter of Examples 43-50, and further including means for storing the second data sub-block in the memory at a second physical address at a first time; and means for determining, at a second time that is subsequent to the first time, whether the second data sub-block is a duplicate of the first data sub-block; and means for setting, in response to a determination that the second data sub-block is a duplicate of the first data sub-block, the second pointer to point to the first physical address in the memory.

Example 52 includes the subject matter of Examples 43-51, and further including means for receiving an instruction to store a second data block, wherein the instruction includes a parameter that indicates the second data block is critical data; means for storing the parameter in a second pointer table that is associated with the second data block; and means for storing each data sub-block of a plurality of data sub-blocks included in the second data block at a respective different physical address in the memory.

Example 53 includes the subject matter of Examples 43-52, and further including means for storing at least the second pointer using a base-delta format.

Example 54 includes the subject matter of Examples 43-53, and wherein the means for storing the first data sub-block comprises means for storing a 64 byte first data sub-block; and the means for storing the first pointer comprises means for storing a 64 bit pointer.

Example 55 includes the subject matter of Examples 43-54, and further including means for receiving an instruction from a host to read the data block; means for sequentially reading each pointer in the pointer table; means for retrieving each respective data sub-block from the memory; and means for concatenating each data sub-block in a buffer for transmission of the data block to the host.

Example 56 includes the subject matter of Examples 43-55, and further including means for receiving a write instruction from a host to write the data block; and means for storing, in response to the write instruction, the data sub-blocks.

Example 57 includes the subject matter of Examples 43-56, and further including means for receiving a trim instruction from a host to trim the data block; means for removing, in response to the trim instruction, the pointers associated with the data sub-blocks of the data block from the pointer table; and means for decrementing reference counts associated with each data sub-block of the data block.

Example 58 includes the subject matter of Examples 43-57, and wherein the means for storing the first data sub-block comprises means for storing the first data sub-block to one of a plurality of non-volatile data storage devices included in the memory.

Example 59 includes the subject matter of Examples 43-58, and wherein the means for storing the first data sub-block comprises means for storing the first data sub-block to one of a plurality of non-volatile byte-addressable write-in-place data storage devices included in the memory.

Example 60 includes the subject matter of Examples 43-59, and further including means for generating a hash of each data sub-block; and means for storing each hash in the memory.

Example 61 includes the subject matter of Examples 43-60, and further including means for performing a bit-by-bit comparison of the second data block to the first data sub-block to determine whether the second data sub-block is a duplicate of the first data sub-block.

Example 62 includes the subject matter of Examples 43-61, and further including means for storing reference counts associated with physical addresses of the plurality of data sub-blocks in a table in the memory.

1. An apparatus comprising:
a memory to store data blocks of data and a pointer table, wherein the pointer table is to store one or more pointers and each pointer points to a physical address of the memory; and
a controller to manage the storage of a data block to the memory, wherein the data block comprises a plurality of data sub-blocks and the controller is to:
store a first data sub-block of the plurality of data sub-blocks in the memory at a first physical address;
store a pointer that points to the first physical address of the memory in the pointer table;
determine whether a second data sub-block of the plurality of data sub-blocks is a duplicate of the first data sub-block; and
store, in response to a determination that the second data sub-block is a duplicate of the first data sub-block, a second pointer in the pointer table, wherein the second pointer points to the first physical address.

2. The apparatus of claim 1, wherein the memory is further to store reference counts associated with physical addresses of the memory; and
the controller is further to:
set the reference count associated with the first physical address after the first pointer is stored; and
increment the reference count associated with the first physical address after the second pointer is stored.

3. The apparatus of claim 1, wherein:
the controller is further to generate a hash of each data sub-block and store each hash in the memory as a pointer to the respective data sub-block.

4. The apparatus of claim 1, wherein the controller is further to compare a first hash generated from the first data sub-block to a second hash generated from the second data sub-block to determine whether the second data sub-block is a duplicate of the first data sub-block.

5. The apparatus of claim 1, wherein the memory is further to store reference counts associated with physical addresses of the memory; and
the controller is further to:
remove the second pointer from the first pointer table; and
decrement a reference count associated with the first physical address after the second pointer is removed.

6. The apparatus of claim 1, wherein the memory is further to store reference counts associated with physical addresses of the memory; and
the controller is further to:
determine that a reference count associated with the first physical address is equal to zero; and
overwrite the first data sub-block in response to the determination that the reference count is equal to zero.

7. The apparatus of claim 1, wherein the controller is further to:
store a second data block that includes a second plurality of data sub-blocks in the memory; and
store a plurality of pointers to physical addresses of the memory corresponding to the stored second plurality of data sub-blocks.

8. The apparatus of claim 1, wherein the controller is further to:
sequentially read each pointer in the pointer table; and
retrieve each respective data sub-block from the memory.

9. The apparatus of claim 1, wherein the controller is further to:
store the second data sub-block in the memory at a second physical address at a first time;
determine, at a second time that is subsequent to the first time, whether the second data sub-block is a duplicate of the first data sub-block; and
set, in response to a determination that the second data sub-block is a duplicate of the first data sub-block, the second pointer to point to the first physical address in the memory.

10. The apparatus of claim 1, further comprising one or more of:
at least one processor communicatively coupled to the memory,
a network interface communicatively coupled to a processor,
a display communicatively coupled to a processor, or
a battery coupled to the apparatus.

11. One or more machine-readable storage media comprising a plurality of instructions stored thereon that, when executed, cause an apparatus to:
store a first data sub-block of a plurality of data sub-blocks of a data block in a memory of the apparatus at a first physical address;
store a pointer that points to the first physical address of the memory in a pointer table;
determine whether a second data sub-block of the plurality of data sub-blocks is a duplicate of the first data sub-block; and
store, in response to a determination that the second data sub-block is a duplicate of the first data sub-block, a second pointer in the pointer table, wherein the second pointer points to the first physical address.

12. The one or more machine-readable storage media of claim 11, wherein the plurality of instructions, when executed, further cause the apparatus to:
set a reference count associated with the first physical address after the first pointer is stored; and
increment the reference count associated with the first physical address after the second pointer is stored.

13. The one or more machine-readable storage media of claim 11, wherein the plurality of instructions, when executed, further cause the apparatus to generate a hash of each data sub-block as a pointer to the respective data sub-block.

14. The one or more machine-readable storage media of claim 11, wherein the plurality of instructions, when executed, further cause the apparatus to compare a first hash generated from the first data sub-block to a second hash generated from the second data sub-block to determine whether the second data sub-block is a duplicate of the first data sub-block.

15. The one or more machine-readable storage media of claim 11, wherein the plurality of instructions, when executed, further cause the apparatus to:
remove the second pointer from the first pointer table; and
decrement a reference count associated with the first physical address after the second pointer is removed.

16. The one or more machine-readable storage media of claim 11, wherein the plurality of instructions, when executed, further cause the apparatus to:
determine that a reference count associated with the first physical address is equal to zero; and
overwrite the first data sub-block in response to determining that the reference count is equal to zero.

17. The one or more machine-readable storage media of claim 11, wherein the plurality of instructions, when executed, further cause the apparatus to:
store a second data block that includes a second plurality of data sub-blocks in the memory; and
store a plurality of pointers to physical addresses of the memory corresponding to the stored second plurality of data sub-blocks.

18. The one or more machine-readable storage media of claim 11, wherein the plurality of instructions, when executed, further cause the apparatus to:
store the second data sub-block in the memory at a second physical address at a first time;
determine, at a second time that is subsequent to the first time, whether the second data sub-block is a duplicate of the first data sub-block; and
set, in response to a determination that the second data sub-block is a duplicate of the first data sub-block, the second pointer to point to the first physical address in the memory.

19. A method comprising:
storing, by a controller of an apparatus, a first data sub-block of a plurality of data sub-blocks of a data block in a memory of the apparatus at a first physical address;
storing, by the controller, a pointer that points to the first physical address of the memory in a pointer table;
determining, by the controller, whether a second data sub-block of the plurality of data sub-blocks is a duplicate of the first data sub-block; and
storing, by the controller and in response to a determination that the second data sub-block is a duplicate of the first data sub-block, a second pointer in the pointer table, wherein the second pointer points to the first physical address.

20. The method of claim 19, further comprising:
setting, by the controller, a reference count associated with the first physical address after the first pointer is stored; and
incrementing, by the controller, the reference count associated with the first physical address after the second pointer is stored.

21. The method of claim 19, further comprising generating, by the controller, a hash of each data sub-block as a pointer to the respective data sub-block.

22. The method of claim 19, further comprising determining, by the controller, that the second data sub-block is a duplicate of the first data sub-block by comparing a first hash generated from the first data sub-block to a second hash generated from the second data sub-block.

23. The method of claim 19, further comprising:
removing, by the controller, the second pointer from the first pointer table; and
decrementing, by the controller, a reference count associated with the first physical address after the second pointer is removed.

24. The method of claim 19, further comprising:
determining, by the controller, that a reference count associated with the first physical address is equal to zero; and
overwriting, by the controller, the first data sub-block in response to determining that the reference count is equal to zero.

25. The method of claim 19, further comprising:
storing, by the controller, a second data block that includes a second plurality of data sub-blocks in the memory; and
storing, by the controller, a plurality of pointers to physical addresses of the memory corresponding to the stored second plurality of data sub-blocks.
